(19) United States
(12) Patent Application Publication
(10) Pub. No.: US 2010/0080393 A1
(43) Pub. Date: Apr. 1, 2010

(54) Cryptographic Key Management In Storage Libraries

(76) Inventors: Stanley S. FEATHER, Berthoud, CO (US); Curtis C. Ballard, Eaton, CO (US); Jonathan P. Buckingham, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,290

(22) Filed: Oct. 1, 2008

(51) Int. Cl. H04L 9/08

(52) U.S. Cl. 380/278

(57) ABSTRACT

Embodiments include methods, apparatus, and systems for managing encryption keys in a storage library. One method includes receiving a request to read or write data to a tape drive; initiating, by the tape drive, a request for an encryption key to encrypt or decrypt the data; and transmitting the encryption to key to the tape drive through an out-of-band path.

### BACKGROUND

Storage automation systems, such as data cartridge storage systems, include a host computer and a data storage device. The data storage device typically comprises a cartridge storage element, input/output (I/O) components, and a moveable cartridge access component, sometimes referred to as a “picker.” The cartridge storage element stores a plurality of data cartridges in an array, and each data cartridge in the array has an associated storage position within the cartridge storage element.

During operation, the data storage device receives read and write requests from the host computer. Data stored on the cartridges can be encrypted. The host computer sends the encryption key and the data to the data cartridge drive. In this operation, the host controls both the encryption keys and data flow.

The timely management of a large number of encryption keys in multiple drives is a difficult task. Hosts need special key management capabilities, and problems arise if different types of hosts attempt to access the same library. Furthermore, keys delivered to cartridge drives through the primary interface may not be secure. For example, such keys are delivered through the primary interface and require physical security because the keys are not encrypted during transmission. This is because of the inherent difficulty securing software on servers that store and transmit both the encryption keys and data to be encrypted.

### BRIEF DESCRIPTION OF THE DRAWINGS

FIG. 1 is a storage system having a cartridge library in accordance with an exemplary embodiment of the present invention.

FIG. 2 is an exemplary flow diagram for writing data using an encryption key in accordance with an exemplary embodiment of the present invention.

FIG. 3 is an exemplary flow diagram for reading data using an encryption key in accordance with an exemplary embodiment of the present invention.

FIG. 4 is an exemplary storage system having a tape library in accordance with an exemplary embodiment of the present invention.

FIG. 5A is a perspective view of a tape drive in accordance with an exemplary embodiment of the present invention.

FIG. 5B is a rear plan view of the tape drive of FIG. 5A in accordance with an exemplary embodiment of the present invention.

### DETAILED DESCRIPTION

Embodiments in accordance with the present invention are directed to apparatus, systems, and methods for automating cryptographic key management in storage systems. One exemplary embodiment automatically and transparently acquires, delivers, clears, and reports cryptographic keys used to encrypt and decrypt data in tape drives that are included in a tape library.

In one exemplary embodiment, encryption keys to encrypt data are sent to the cartridge drive without knowledge of the host computer writing or reading the data. As such, encryption transactions are transparent to the host computer. Further, the keys are requested by the cartridge drive and provided in real-time in a “just-in-time” fashion (i.e., provided when needed and/or requested by the tape drive).

In one embodiment, the encryption keys are sent independent of the data. For example, encryption keys are sent through an out-of-hand path. By way of example, the encryption keys and data are transmitted down different paths to the cartridge or tape drive. Since the encryption keys and data are separated, the encryption keys are more secure (for example, as opposed to transmitting the keys and data along the same paths and/or through the same ports).

The cartridge drive is configured to notify the library when a key is needed or required to encrypt or decrypt data. Drives therefore initiate requests for keys (as opposed to passively receiving a key via a command). For example, when a storage library receives a write or read command or input/output (I/O) request, the cartridge drive receives that command and then initiates a request for the appropriate key. In one embodiment, such requests are transmitted to the storage library. The storage library obtains the requested key and transmits it to the drive. The drive continues to use the key until no key is required, or a different key is required. In some instances, the key can be correct but another parameter indicates that they key cannot be used for this operation so the tape drive will request a new set of encryption parameters.

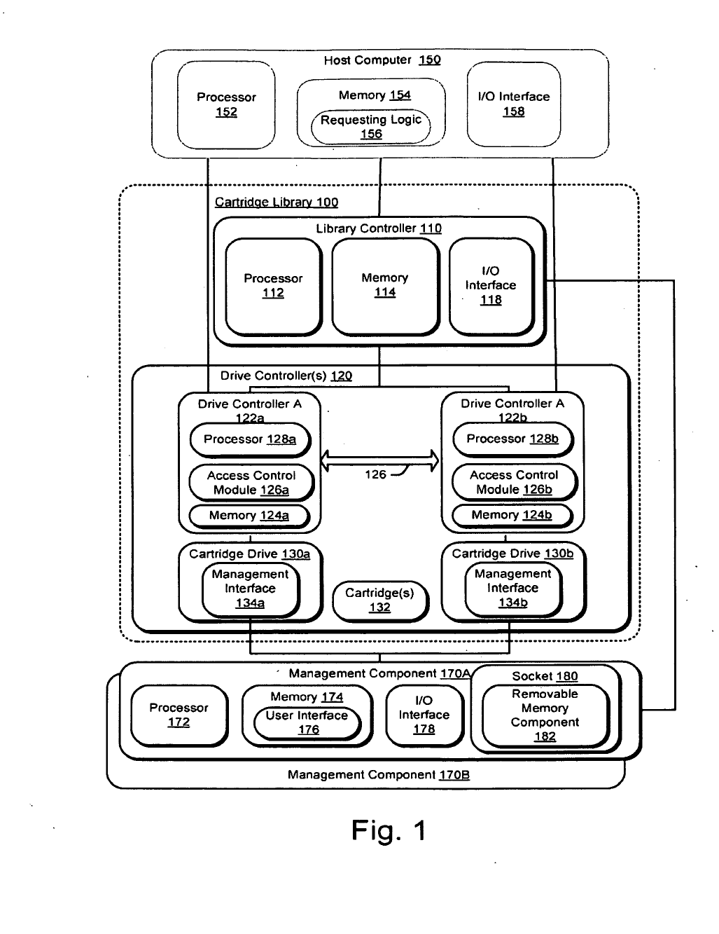

FIG. 1 is an exemplary storage system having a cartridge library 100 in accordance with an exemplary embodiment of the present invention. In one embodiment, the cartridge library 100 is a tape library that includes at least one library controller module 110, including a processor 112 which is coupled to a memory 114, an I/O interface 118, and one or more cartridge drive controllers 120. The library controller 110 is coupled to the cartridge drive controllers 120 via one or more interface buses such as, e.g., an RS422 bus or an inter-integrated circuit (I2C) bus. It is noted that the library controller 110 can be embodied as a separate component (as shown), or can be accessed through one or more of the drive controllers 120, or within a separate host computer 150.

In one embodiment, the library controller 110 is implemented as a software module that runs on a general purpose processing unit of the tape library, or as a special-purpose chipset.

In some embodiments, the host computers 150 connect to the drive controllers and the library controller by another bus. By way of example, the host computers 150 connect to the library and drives using buses with SCSI protocols, and the library connects to the drives using RS422.

The cartridge drive controllers 120 coordinate data transfer to and from the one or more cartridge drives 130a-130b. In one embodiment, the library includes two cartridge drive controllers: a first cartridge drive controller 122a and a second cartridge drive controller 122b. Cartridge drive controllers 122a and 122b have respective processors 128a and 128b, respective memories 124a and 124b, and respective access control modules 126a and 126h. Processors 128a, 128b can be implemented as general purpose processors that execute logic instructions in the respective memories 124a, 124b, or can be implemented as special purpose processors adapted to implement logic instructions embodied as firmware, or as ASICs. The memories 124a and 124h can be implemented as battery-hacked, non-volatile memory, such as flash memory or one or more of random access memory (RAM), dynamic RAM (DRAM), synchronous DRAM (SDRAM), and the like. Although only two controllers 122a and 122h are shown and discussed generally herein, aspects of this invention can be extended to other multi-controller configurations where more than two controllers are employed.

The cartridge drives 130a, 130b are configured to receive a tape cartridge 132. Input/Output (I/O) operations requested by host computer 150 are executed against data stored in the tape cartridges 132.

In some embodiments, tape library 100 is coupled to plural management components 170A and 170B. In one embodiment, the management components 170A and 170E are separate from each other and can be located internal or external to the tape library 100. By way of example, management components 170A, 170B are embodied as an integrated computing device such as, e.g., a blade server implemented on a printed circuit board (PCB) that couples to an expansion slot in tape library 100. Alternatively, the management components are embodied as a stand-alone computing device such as, e.g., a server, coupled to tape library 100 via a communication link, such that management components are coupled to multiple tape libraries 100.

Each management component 170A and 170B includes a processor 172, a memory module 174, and an I/O interface 178. Processor 172 can be embodied as a general purpose computer processor. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. Memory 174 includes one or more of random access memory (RAM), dynamic RAM (DRAM), synchronous DRAM (SDRAM), and the like. For example the memory 174 includes an operating system to manage operations of the management component. The operating system can include (or manage) one or more communication interfaces such as I/O interface 178 to receive data packets and/or data streams from a remote source. The I/O interface 178 can include a parallel port (e.g., a small computer system interlace (SCSI) port), Ethernet, or other type of known or future developed data communication port.

In some embodiments management component includes a removable non-volatile memory component (RNMC) 182 coupled via a socket 180 that provides a conductive connection between the RNMC 182 and other components of the management component. The RNMC 182 can store operational and control management data associated with the tape library 100.

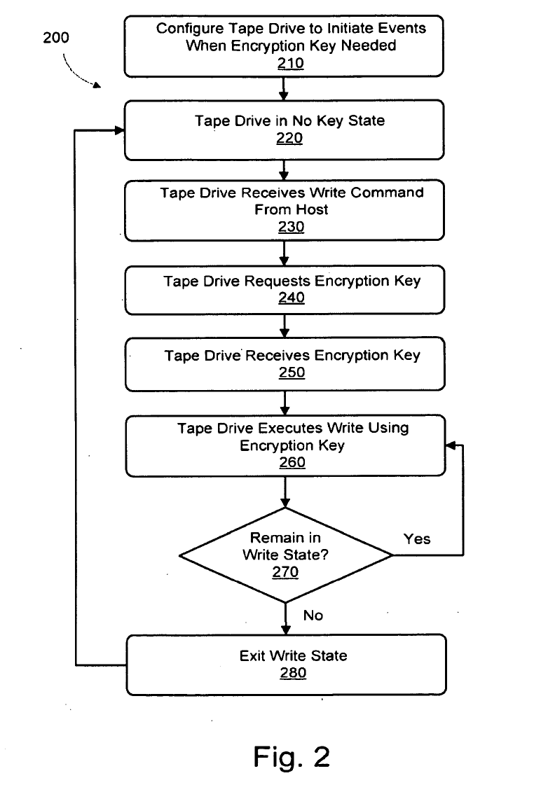

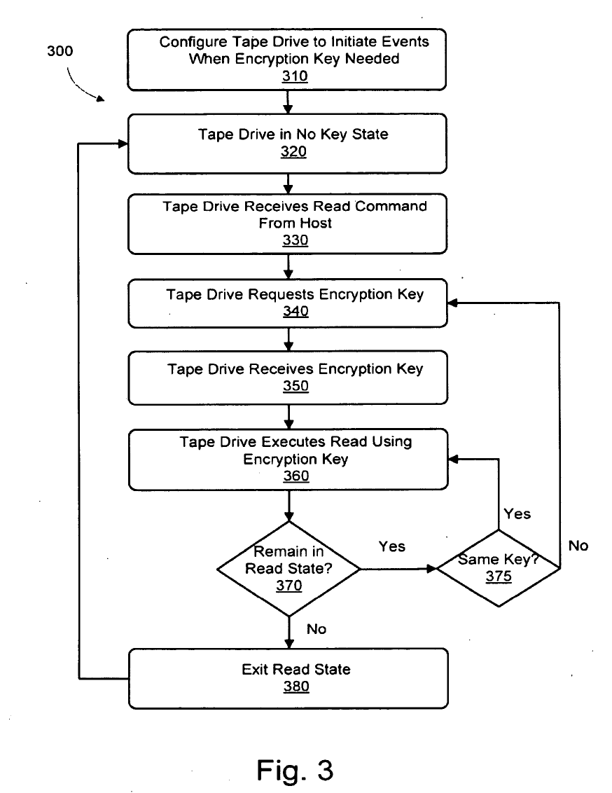

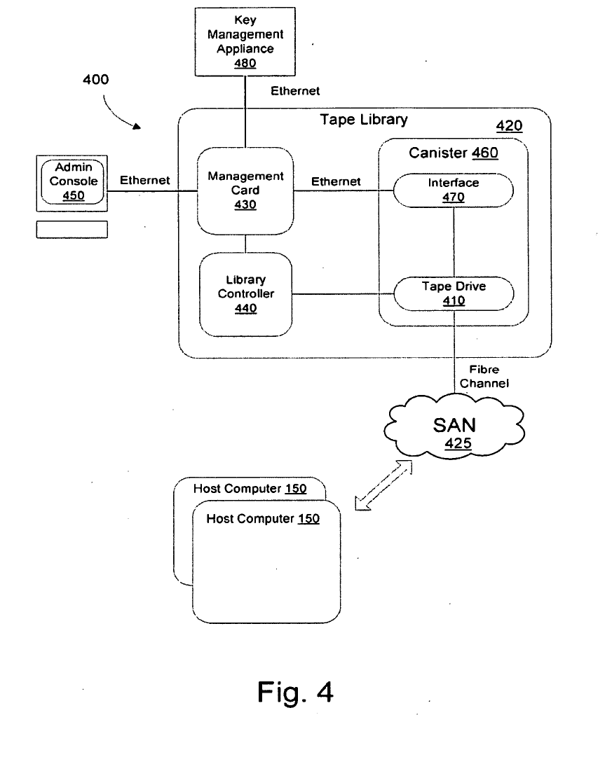

Exemplary embodiments in accordance with the invention are further discussed in connection with FIGS. 2 and 3. Specifically, FIGS. 2 and 3 are exemplary flow diagrams using encryption keys to perform reads and writes to storage devices in storage systems, such as storage systems discussed in FIGS. 1 and 4.

FIG. 2 is an exemplary flow diagram 200 for writing data using an encryption key in accordance with an exemplary embodiment of the present invention.

According to block 210, the tape drive is configured to notify the library when the encryption key is needed. In one embodiment, the tape drive determines when an encryption key is needed and initiates requests for such keys.

According to block 220, the tape drive is initially in a no key state. In one embodiment, three different states exist: (1) a no key state, (2) a write state, and (3) a read state. In the no key state, the tape drive has not requested an encryption key and is neither reading nor writing data to a tape cartridge. By contrast, in the write state, the tape drive has received an encryption key for encrypting and writing data to a tape cartridge. In the read state, the tape drive has received an encryption key for decrypting and reading data from the tape cartridge.

According to block 230, the tape drive receives a write command from a host computer. For example, a host computer sends a write request to the tape library, and this request is transmitted to the tape drive.

According to block 240, the tape drive requests an encryption key. In one embodiment, the key is requested at a point in time when the key is needed (as opposed to receiving the key before it is requested or receiving it from an unsolicited request). In one embodiment, the request is initiated upon receiving the write command. As one example, the drive requests the encryption key, and the library receives the request for the encryption key. The library then acquires an encryption key for encryption and transmits this acquired key to the tape drive.

In one exemplary embodiment, requests for encryption keys are sent from the tape drive to the tape library, or the tape library monitors the tape drive for request indicators (for example, polling). For instance, the tape drive sends the key request to a key manager in the tape library. In another embodiment, key requests are transmitted to a key manager that is external to the tape library (for example, a host or server remote from the tape library). By way of illustration, the key manager, or the library, or both, may execute encryption policies which control attributes of the key, and whether the requested key is created or acquired.

According to block 250, the tape drive receives the encryption key. As noted, this key can be received from an internal source in the tape library (for example, a key manager) or from a source external to the tape library (for example, a key manager located in a host or server). The key manager, or the tape library, or both, may also provide the tape drive with a key identifier sufficient to identify the key when the data is later read. By way of example, the key manager is shown as a management component 170B in FIG. 1 or key management appliance 480 in FIG. 4.

According to block 260, the tape drive executes the write using the encryption key. Specifically, data is encrypted with the encryption key and written to a tape cartridge that is loaded in the tape drive.

According to block 270, a question is asked whether to remain in the write state. If the answer to this question is “yes” then flow proceeds back to block 260. Here, the tape drive continues to use the encryption key to encrypt data and execute writes. By way of example, the tape drive can remain in the write state with the current encryption key until a predetermined event occurs (for example, until the tape is unloaded, until the tape drive receives a re-position command, etc.). One event that will kick the drive out of a write state is a read request.

If the answer to the question is “no” then flow proceeds to block 280. Here, the tape drive exits the write state, and flow proceeds back to block 220 where the tape drive enters back to the no key state.

FIG. 3 is an exemplary flow diagram 300 for reading data using an encryption key in accordance with an exemplary embodiment of the present invention.

According to block 310, the tape drive is configured to initiate events when the encryption key is needed. In one embodiment, the tape drive determines when an encryption key is needed and makes requests for such keys.

According to block 320, the tape drive is initially in a no key state. As noted above, the no key state is one of three states (no key state, write state, and read state).

According to block 330, the tape drive receives a read command from a host computer. For example, a host computer sends a read request to the tape library, and this request is transmitted to the tape drive.

According to block 340, the tape drive requests an encryption key. In one embodiment, the key is requested at a point in time when the key is needed (as opposed to receiving the key before it is requested or receiving it from an unsolicited request). In another embodiment, the key is requested when the tape is loaded.

In one exemplary embodiment, requests for encryption keys are sent from the tape drive to the tape library. For instance, the tape drive sends the key request to a key manager in the tape library. In another embodiment, key requests are transmitted to a key manager that is external to the tape library (for example, a host or server remote from the tape library). By way of illustration, the key manager obtains a key identifier from the tape media, and matches the key identifier with the appropriate encryption key.

According to block 350, the tape drive receives the encryption key. As one example, the tape drive requests the encryption key, and the library receives the request for the encryption key. The library then acquires an encryption key for decryption and transmits this acquired key to the tape drive. As noted, this key can be received from an internal source in the tape library (for example, a key manager) or from a source external to the tape library (for example, a key manager located in a host or server).

According to block 360, the tape drive executes the read using the encryption key. Specifically, data is read from a tape cartridge loaded in the drive and decrypted with the encryption key before being returned to the host.

According to block 370, a question is asked whether to remain in the read state. If the answer to this question is “yes” then flow proceeds to block 375 where a determination is made as to whether the same key is will be used. If the answer to this question is “yes” then flow proceeds to block 360. Here, the tape drive attempts to continue to use the encryption key to encrypt data and execute reads. By way of example, the tape drive can remain in the read state with the current encryption key until a predetermined event occurs (for example, until the tape is unloaded or the tape drive transitions to a write state). If the answer to the question is “no” (i.e., the read command encounters data that requires a different encryption key), then flow proceeds back to block 340, and the tape drive requests the new encryption key from the key manager.

If the answer to the question of block 370 is “no” then flow proceeds to block 380. Here, the tape drive exits the read state; and flow proceeds back to block 320 where the tape drive enters back to the no key state.

FIG. 4 is an exemplary storage system 400 in accordance with an exemplary embodiment of the present invention. The storage system includes a tape library 420 connected to an administrative console 450 and one or more host computers 150 via one or more networks (for example, shown as a storage area network 425 or SAN).

The tape library 420 includes a canister 460 housing an interlace 470 and tape drive 410. A management card 430 couples to a library controller 440, canister 460 (for example, via an Ethernet connection), and the administrative console 450 (for example via an Ethernet connection). A key management appliance 480 couples (for example via an Ethernet connection) to the tape library 420. The key management appliance 480 can be internal or external to the tape library. Furthermore, the key management appliance 480 is not required to couple to a management card but can connect directly to the tape drive.

In one exemplary embodiment, the administrative console 450 enables a user or administrator to select and/or administer encryption policies in the key manager 480 that apply to the tape library 420 and its components. In another embodiment, the key manager may be internal to the library. The encryption policies can be independent of the software at the hosts writing the data. As such, hosts are not required to have special key management capabilities to read and write encrypted data to a tape drive.

In one embodiment, the tape drives can directly encrypt and decrypt data. This process involves transmitting cryptographic keys to the drive prior to writing or reading data and can involve clearing these keys following their use. Exemplary embodiments automate such tasks in the tape library so that cryptographic keys are retrieved and cleared when needed. Key usage is reported without requiring manual steps once the capability has been enabled. Furthermore, in one embodiment, the keys are not delivered through the primary interface but through an out-of-hand interface via a management interface internal to the tape library. This process is secure because of the inherent difficulty securing software on servers that transmit both the keys and the data to be encrypted.

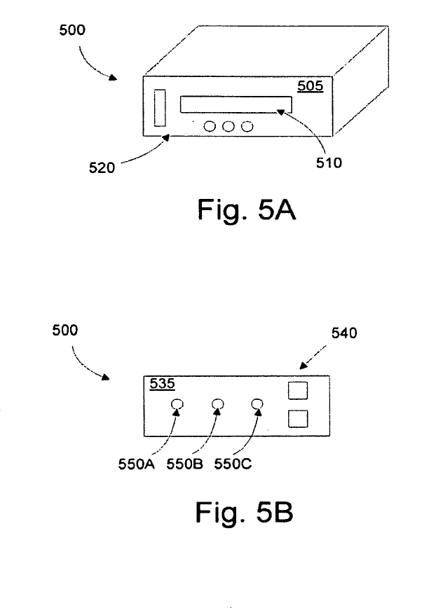

FIGS. 5A and 5B show one exemplary removable media device, such as a tape drive 500 in accordance with embodiments of the invention. Generally, the tape drive has a front side or panel 505 that includes a tape access door 510 and various controls and displays 529. A back side or panel 535 includes various connectors, ports, cable attachments, power, etc. (shown generally at 540).

In one exemplary embodiment, the tape drive 500 includes plural ports 550A-550C. At least one of these ports is a data port, and one port is used for encryption management. The management and data ports are separately provided such that encryption keys may be provided to enable encryption and decryption without interfering with data traffic transmitting through the data port.

By way of example, one of the ports functions as an out-of-hand path while another port functions as an in-band path. For illustration, port 550A is the out-of-band port, and port 550B is an in-band port. When a key is needed to encrypt or decrypt data, the request and key are sent through the port 550A which is configured not to receive data from host computers. In one embodiment, this port is not connected or coupled to the hosts. At the same time, data being read from and/or written to the tape drive is transmitted through the port 550B which is configured to receive data from host computers. In this configuration, encryption keys are securely communicated and transmitted to the tape drive using a separate, distinct path and/or port without interfering with data being transmitted to or from a host.

In one embodiment, the tape drive notifies the tape library through an out-of-band path or port when an encryption key is required. The library obtains the requested key from a source (for example, a source internal to the tape library or a source external to the tape library). The tape library then transmits the requested key to the tape drive through the out-of-hand path or port. The tape drive then notifies the tape library through this out-of-band path or port when usage of the key is completed.

The path used to transmit the cryptographic key to the tape drive is more secure since the path is internal to the library enclosure. This path is not vulnerable to attack as the storage area network. In another embodiment, the path is external to the library but can use a transmission protocol that has security methods not available to a data transfer port, such as SSL (Secure Sockets Layer) over Ethernet. Further, the source of the key can be independent of the software application writing or reading the data. In one embodiment, this source (such as a key management appliance) is highly secure. The tape library consistently applies the same security practices independent of the various software applications writing or reading the data.

Embodiments in accordance with the present invention are utilized in a variety of systems, methods, and apparatus. For illustration, exemplary embodiments are discussed in connection with a tape library. Exemplary embodiments, however, are applicable to other types of storage systems, such as storage devices using cartridges, hard disk drives, optical disks, or movable media.

In one exemplary embodiment, one or more blocks in the flow diagrams are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

In exemplary embodiments, the architectures and methods can be implemented in tape storage libraries such as the tape storage libraries described in U.S. Pat. Nos. 5,926,341; 6,028,733; or 6,421,306, commonly assigned to the assignee of the present application, the disclosures of which are incorporated by reference herein in their entirety.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive, flash memory, or hard drive. The software programming code is embodied or stored on any of a variety of known media for use with a data processing system or in any memory device such as semiconductor, magnetic and optical devices, including a disk, hard drive, CD-ROM. ROM, flash memory, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
receiving a request to read or write data to a tape drive;
initiating, by the tape drive, a request for an encryption key to encrypt or decrypt the data;
transmitting the encryption key to the tape drive through an out-of-band path.

2) The method of claim 1, wherein the out-of-band path occurs through a port on the tape drive that is configured not to receive data from host computers.

3) The method of claim 1 further comprising, transmitting the encryption key to the tape drive from a source that is independent of a software application requesting to read or write the data.

4) The method of claim 1 further comprising:
transmitting the request for the encryption key from the tape drive to a tape library;
obtaining the encryption key from a key manager located internal or external to the tape library.

5) The method of claim 1, wherein the request for the encryption key is transmitted transparent to a host computer making the request to read or write the data.

6) The method of claim 1 further comprising:
transmitting the encryption key through a first port on the tape drive;
transmitting the data through a second port on the tape drive.

7) A computer readable medium having instructions for causing a computer to execute a method, comprising:
initiating, by a tape drive in a tape library, a request for a cryptographic key to encrypt or decrypt data;
transmitting the cryptographic key to the tape drive through a first port on the tape drive;
transmitting the data through a second port on the tape drive.

8) The computer readable medium of claim 7 further comprising, transmitting the data and the cryptographic key along different paths to the tape drive.

9) The computer readable medium of claim 7 further comprising, requesting, by the tape drive, the cryptographic key upon receiving a command to read or write data to a tape cartridge.

10) The computer readable medium of claim 7 further comprising, configuring the tape drive to initiate requests for the cryptographic key.

11) The computer readable medium of claim 7 further comprising:
transmitting the request from the tape drive to the tape library;
retrieving, by the tape library, the cryptographic key;
transmitting the cryptographic key from the tape library to the tape drive.

12) The computer readable medium of claim 7 further comprising, continuing to use the cryptographic key to encrypt or decrypt data until the tape drive receives a command that prompts the tape drive to discontinue use of the cryptographic key or processes an event that prompts the tape drive to discontinue use of the cryptographic key.

13) The computer readable medium of claim 7 further comprising, acquiring a new cryptographic key when the tape drive transitions from a read state to a write state.

14) The computer readable medium of claim 7 further comprising, waiting to initiate the request for the cryptographic key until either a read command or write command is received at the tape drive.

15) The computer readable medium of claim 7, wherein the first port is an out-of-band path.

16) A storage system, comprising:
a tape drive having a first port and a second port, the second port receiving read and write requests from a host connected to the tape drive through a storage area network, and the first port requesting and receiving encryption keys to encrypt and decrypt data for the read and write requests.

17) The storage system of claim 16, wherein the tape drive notifies a tape library through the first port when usage of an encryption key is completed.

18) The storage system of claim 16, wherein a tape library polls the tape drive to detect that an encryption key is needed.

19) The storage system of claim 16 further comprising, a key manager that maintains the encryption keys.

20) The storage system of claim 19, wherein the first port includes an out-of-band path that cannot receive data from host computers.
